(19) United States
(12) Patent Application Publication
(10) Pub. No.: US 2025/0262843 A1
(43) Pub. Date: Aug. 21, 2025

(54) METHOD FOR MANUFACTURING A GLAZED UNIT

(71) Applicant: SAINT-GOBAIN GLASS FRANCE, COURBEVOIE (FR)

(72) Inventor: Thibault RAPENNE, NOYON (FR)

(21) Appl. No.: 18/856,753

(22) PCT Filed: Apr. 13, 2023
(86) PCT No.: PCT/EP2023/059669

§ 371 Date: Oct. 14, 2024

(30) Foreign Application Priority Data
Apr. 14, 2022 (FR) 2203456

(51) Int. Cl. B32B 17/10

(52) U.S. Cl. CPC B32B 17/10302; B32B 17/10036; B32B 17/10091; B32B 17/10889; B32B 17/1099; B32B 17/10761; B32B 17/10779; B32B 2605/00

(57) ABSTRACT

A glazed unit of curved form includes a first glass sheet with a thickness of less than 1.6 mm, a second glass sheet having a thickness of less than 1.6 mm, an intermediate film with a thickness of less than the thickness of the thinnest glass sheet of the glazed unit and arranged between the first glass sheet and the second glass sheet, the glazed unit further including a seal encapsulating all the sides of the glazed unit.

It is known to form car windows with a shape, in particular automotive side glazed units, by a toroidal bending method. These conventional car side windows are monolithic glass panes heated to 650° C., then abruptly cooled in order to temper them while giving them a toroidal shape. These tempered glazed units have the double advantage of being more resistant to mechanical stress as well as of fragmenting into a multitude of small pieces in the event of breaking.

The manufacture of a laminated glazed unit on the basis of these conventional car side windows consists of a sandwich of two glass panes formed and hardened (in the sense that they are abruptly cooled) connected by a sheet of an elastomeric interlayer made of PVB.

For the manufacture of small-sized windows, the same tools as for conventional windows are used, although not without raising logistical concerns (handling and storage of small glass panes) and industrial production (use of large-size facilities of high energy consumption to produce small glazed units).

Furthermore, for thin glass panes, all shaping is carried out by cold bending, but systematically with a support glass pane: whether with a thick tempered glass serving as support for the lamination, or else with piston glass panes in order to shape a sandwich of thin glass panes. The shaping of thin glass panes is very complex and cold bending therefore seems the best option to achieve it, the proposed solutions systematically involving a “master” glass pane in order to guarantee the good geometry of the sandwich (in the case of small quarter-panel type glazed units, it would therefore be necessary to continue forming a small tempered glass pane in order to have an assembly with a thin glass pane on one of the two sides).

There is therefore a need to find an alternative solution.

### SUMMARY OF THE INVENTION

The present invention seeks to provide an alternative solution to the prior art, namely a method making it possible to produce a thin, curved, laminated glazed unit in a simple and industrial manner.

To this end, the present invention relates to a glazed unit of curved shape comprising a first glass sheet with a thickness of less than 1.6 mm and more preferentially less than 1.2 mm, a second glass sheet having a thickness of less than 1.6 mm and more preferentially less than 1.2 mm, an intermediate film with a thickness of less than the thickness of the thinnest glass sheet of the glazed unit and arranged between the first glass sheet and the second glass sheet, the glazed unit further comprising a seal encapsulating all the sides of said glazed unit

The invention further relates to a laminated glazed unit of curved shape resulting from the assembly of a first flat glass sheet with a thickness of less than 1.6 mm and more preferentially less than 1.2 mm, an interlayer sheet and a second glass sheet with a thickness of less than 1.6 mm and more preferentially less than 1.2 mm, the second glass sheet also being flat before it is assembled with the first glass sheet and the interlayer sheet, said glazed unit further comprising a seal encapsulating all its sides and wherein the assembly is carried out in order to give the glazed unit its shape and put the seal in place.

According to one example, the first glass sheet and/or the second glass sheet is chemically or thermally strengthened.

According to one example, the seal is strengthened by a reinforcing member.

According to one example, the reinforcing member comprises at least one metal wire embedded in the seal.

According to one example, the interlayer film is a sheet made of a PVB or PET type material.

According to one example, the interlayer film is a layer deposited on one of the two glass sheets of said glazed unit.

According to one example, the layer forming the interlayer film is an OCA resin or a natural rosin.

According to one example, the glazed unit has a maximum deflection of 70 mm.

According to one example, the glazed unit has a thickness not exceeding 4 mm, more preferentially 3 mm and even more preferentially 2 mm.

According to one example, the glazed unit has a maximum surface area of 0.8 m².

The invention further relates to a method for manufacturing a glazed unit of curved shape comprising a first glass sheet with a thickness of less than 1.6 mm and more preferentially less than 1.2 mm, a thermoplastic interlayer sheet and a second glass sheet having a thickness of less than 1.6 mm and more preferentially less than 1.2 mm, said method comprising:
Providing the first glass sheet in flat form, the second glass sheet in flat form and the interlayer film;
Assembling the first glass sheet in flat form, the second glass sheet in flat form and the interlayer film with the interlayer film between the two glass sheets to form an assembly;
Placing the assembly in an encapsulation device capable of surrounding the sides of the assembly with a seal;
Putting the seal in place;

Characterized in that said encapsulation device is capable of deforming the glazed unit during the placement of the seal.

According to one example, the method further comprises, before the assembly step, a step of chemically or thermally strengthening the first glass sheet and/or the second glass sheet.

### DESCRIPTION OF THE FIGURES

Other particular features and advantages will become clear from the following description thereof, given by way of indication and entirely non limitingly, with reference to the appended drawings, in which:

FIG. 1 shows a curved laminated glazed unit;

FIG. 2 shows a curved laminated glazed unit according to the invention;

FIGS. 3 to 9 schematically show, in cross section, the different steps of the method for manufacturing the glazed unit according to the invention;

### DETAILED DESCRIPTION

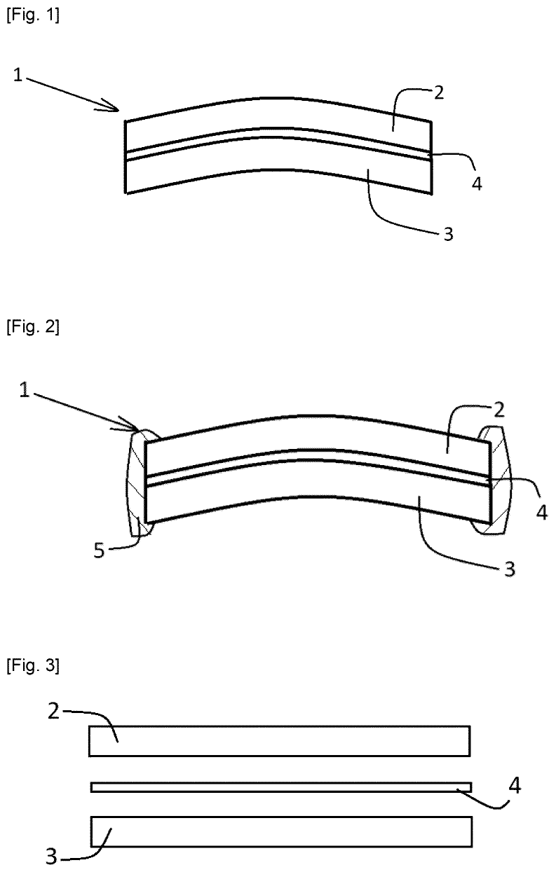

A glazed unit 1 according to the invention is a laminated glazed unit, visible in FIG. 1, comprising an outer glass pane 2 or first sheet, an inner glass pane 3 or second sheet and an interlayer film 4. The interlayer film 4 is arranged between the outer glass pane and the inner glass pane.

The outer glass pane 2 is a glass pane having a thickness of less than 1.6 mm and more preferentially less than 1.2 mm.

The inner glass pane 3 is a glass pane having a thickness of less than 1.6 mm and more preferentially less than 1.2 mm.

The glazed unit 1 comprises two glass sheets of the same thickness or of different thicknesses.

The interlayer film 4 has a thickness less than the thickness of the thinnest glass pane of the sandwich, or in other words the thickness of which is less than 50% of the complete thickness of the glazed unit. Preferentially, the interlayer film has a thickness smaller than that of the thinnest glass sheet, having the smallest thickness. The interlayer film 4 may be in the form of a sheet or a film and may be made of a thermoplastic material such as a PVB or a PET.

The glazed unit 1 has a thickness which does not exceed 4 mm, more preferentially 3 mm and even more preferentially 2 mm.

The glazed unit 1 is produced, firstly, by obtaining the outer glass and the inner glass.

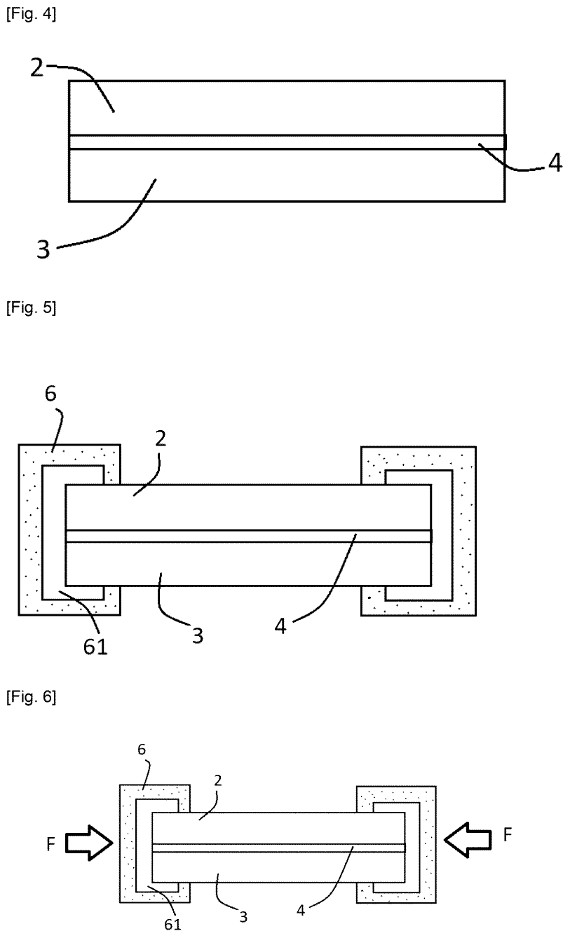

In a second step, the inner glass 3 and the outer glass 2 are assembled with the interlayer film 4, the latter being placed between the two glass panes 2, 3 in order then to undergo the conventional assembly process, as can be seen in FIGS. 3 and 4. This assembly process can comprise a calendering step, then a heating step in a retort oven. Once the glazed unit 1 has been formed, the method consists in shaping it to form a curved glazed unit.

Cleverly according to the invention, the shaping of the glazed unit 1 is carried out at the same time as its encapsulation. Indeed, the encapsulation consists in providing said glazed unit 1 with a peripheral seal 5, as can be seen in FIG. 2, going around and extending over all the sides of the glazed unit. This encapsulation is useful for glazed units intended to be inserted into a window opening. This seal 5 is made of a vulcanized TPE type material such as a PP/EPDLM or SEBS.

For this, the encapsulation step uses an encapsulation device comprising a mold 6 wherein at least a portion of the glazed unit is inserted and wherein the material of the seal is injected, as can be seen in FIG. 5.

This mold 6 comprises, for example, at least two dies enclosing the glazed unit to form a space 61 wherein the material is injected. The seal 5 extends over the entire periphery of the glazing, the mold 6 being arranged accordingly.

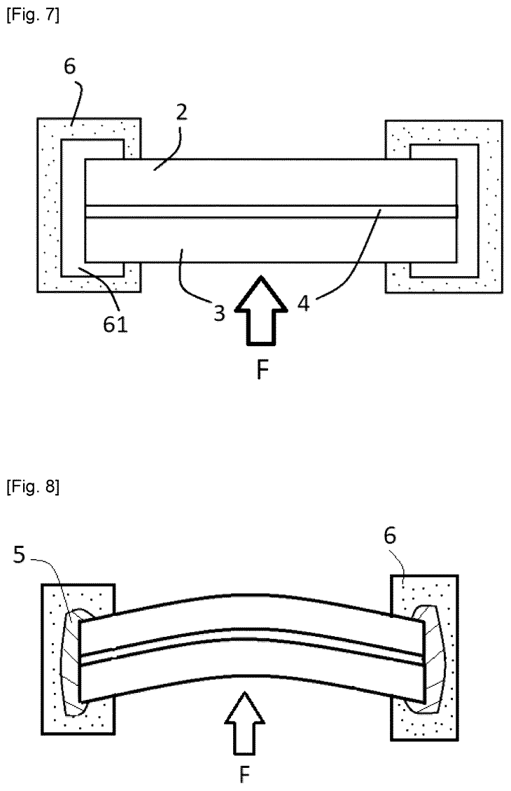

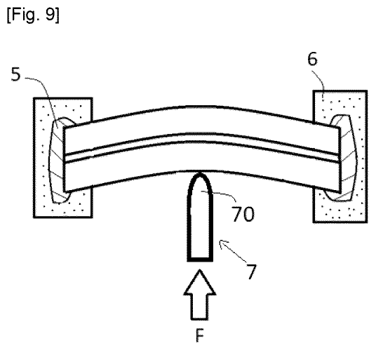

According to the invention, the encapsulation device further comprises a means for deforming the glazed unit 7 used to give the curvature to said glazing. This deformation means 7 of the glazed unit comprises at least one actuator 70, as can be seen in FIG. 9, controlled by a computer for applying at least one force F onto the glazed unit to deform it. This can be the resultant force of at least a suction and/or at least a physical contact such as stretching, a thrust as can be seen in FIGS. 6 and 7. Indeed, the encapsulation device can be equipped with at least two different actuators 70 in order to provide the glazed unit with curvature. In a non-limiting example, the encapsulation device 7 may comprise a finger-type actuator 70 which comes into contact with the glazed unit in order to begin to give it a curved shape. Subsequently, at least one actuator 70 of the suction type such as a suction bell can take over from the finger actuator.

Thus, during encapsulation, the encapsulation device is used to simultaneously deposit the seal 5 onto the sides of the glazing while deforming it as shown in FIG. 8.

The advantage of this simultaneous encapsulation and forming is that the invention uses encapsulation in order to secure the forming. Indeed, the forming essentially consists of cold forming. This cold forming of the glazed unit means that when the force that is applied to it in order to form it is attenuated or disappears, said glazed unit seeks to resume its initial shape.

However, the advantage of the invention is that the encapsulation seal 5, which is placed simultaneously during the forming of the glazed unit, will harden. This hardening of the seal 5 takes place while the forming is still in progress, that is, the force exerted on the glazing in order to give it the desired shape is always applied. When the seal 5 hardens and reaches a certain level of hardness, it makes it possible to fix the position of the glazed unit 1 by opposing the return thereof to its initial position.

The present invention thus makes it possible to produce a thin but laminated glazed unit 1 and therefore with all the advantages of the laminated glass (anti-intrusion/acoustic/anti-UV, etc.) while drastically reducing their thickness and their mass. Today, the minimum thickness of laminated products is 3.96 mm for 8 kg/m, while the present invention easily makes it possible to lower that to around 3 mm (7.5 kg/m²) or even 2 mm (5 kg/m²).

The glazed unit according to the invention has a shape that can be cylindrical or spherical or have a complex shape. The glazed unit obtained may have a maximum deflection of 70 mm. The glazed unit obtained is also characterized by its surface area, said area having a maximum value of 0.8 m². The surface area and the deflection value may be linked, that is, the larger the surface area, the greater the deflection. Thus, for example, for a surface area of 0.8 m², it will be possible to have a deflection of 50 mm and for a surface area of 0.1 m², a deflection of 35 mm.

In a first variant, the outer glass pane (or first sheet) 2 and/or the inner glass pane (or second sheet) 3 undergoes, prior to the assembly of the glazed unit, a hardening or strengthening procedure. This strengthening may be chemical or thermal.

According to a first option, this hardening method is a chemical tempering. This consists in totally immersing the glass pane used into a molten salt bath, subject to a temperature close to 400° C. The bath of very particular salts allows a chemical exchange that will have the effect of durably compressing the outer surface of the glass pane.

According to a second option, this hardening method is a thermal strengthening method. This consists in heating the glass and then cooling it abruptly to generate a given stress in the glass pane. Unlike thermal tempering on a thick glass pane in which the stresses in the glass come from a high thermal gradient, the thermal strengthening method generates a stress via a limited thermal gradient in the glass due to its low thickness.

In a second variant, the seal 5 is reinforced. It is thus understood that the seal comprises a reinforcing member. This reinforcing member comprises, for example, a metal wire placed in the space formed by the mold 6 where it is overmolded, embedded in the material forming the seal. Of course, the reinforcement may be in the form of any member that can fulfill the same function. This reinforcement of the seal, which helps to maintain the curve of the glazed unit, makes it possible to use a material for the seal that is less strong. Alternatively, this reinforcement of the seal makes it possible to apply a greater stress to the glass while ensuring that the seal can maintain this curve.

In a third variant, the interlayer film 4 between the two glass panes is chosen to be thinner than a PVB interlayer commonly used. For this, the interlayer is a material of the OCA (Optical clear adhesive) type resin or natural rosin, that is, the interlayer is in the form of a layer. In this variant, the method for manufacturing the glazed unit comprises the following steps:
Cutting the glass panes from a large substrate then optional chemical tempering
Depositing the layer forming the interlayer on one of the two glass panes. The thickness of the layer is less than 100 μm ideally less than 30 μm. This layer is dried by UV drying.
Assembling the two glass panes by calendering (with passage at 90° C.)
Forming during encapsulation.

In the case where the glass panes undergo hardening by chemical tempering, it may be considered that the chemical tempering is done before or after the cutting. Indeed, the glass panes to form a glazed unit are derived from a jumbo-sized flat glass sheet called PLF, the dimensions of which are for example 3 m×6 m. These jumbo-sized sheets are then cut to the proper shape and dimensions. Thus, if the chemical tempering can be carried out after the cutting of the inner and outer glass panes, it is possible for the tempering to be carried out before cutting.

Of course, the present invention is not limited to the illustrated example but is susceptible to various variants and modifications which will become apparent to the person skilled in the art.
cm 1. A glazed unit having a curved shape comprising a first glass sheet with a thickness of less than 1.6 mm, a second glass sheet having a thickness of less than 1.6 mm, an intermediate film having a thickness of less than the thinnest thickness of the glass sheet of the glazed unit and arranged between the first glass sheet and the second glass sheet, the glazed unit further comprising a seal encapsulating all the sides of said glazed unit. cm 2. A laminated glazed unit of curved shape resulting from the an assembly of a first flat glass sheet with a thickness of less than 1.6 mm, an interlayer sheet and a second glass sheet having a thickness of less than 1.6 mm, the second glass sheet also being flat before it is assembled with the first glass sheet and the interlayer sheet, said glazed unit further comprising a seal encapsulating all its sides and wherein the assembly is carried out in order to give the glazed unit its shape and put the seal in place. cm 3. The glazed unit according to claim 1, wherein the first glass sheet and/or the second glass sheet is chemically or thermally strengthened.

4. The glazed unit according to claim 1, wherein the seal is reinforced by a reinforcing member. cm 5. The glazed unit according to claim 4, wherein the reinforcing member comprises at least one metal wire embedded in the seal. cm 6. The glazed unit according to claim 1, wherein the interlayer film is a sheet made of a PVB or PET type material. cm 7. The glazed unit according to claim 1, wherein the interlayer film is a layer deposited on one of the two glass sheets of said glazed unit. cm 8. The glazed unit according to claim 7, wherein the layer forming the interlayer film is an optical clear adhesive (OCA) resin or a natural rosin. cm 9. The glazed unit according to claim 1, one of the preceding claims, wherein the glazed unit has a maximum deflection of 70 mm. cm 10. The glazed unit according to claim 1, wherein the glazed unit has a thickness not exceeding 4 mm. cm 11. The glazed unit according to claim 1, wherein the glazed unit has a maximum surface area of 0.8 m². cm 12. A method for manufacturing a glazed unit of curved shape comprising a first glass sheet with a thickness of less than 1.6 mm, a thermoplastic interlayer sheet and a second glass sheet having a thickness of less than 1.6 mm, said method comprising:
obtaining the first glass sheet in flat form, the second glass sheet in flat form and the interlayer film;
assembling the first glass sheet in flat form, the second glass sheet in flat form and the interlayer film with the interlayer film between the two glass sheets to form an assembly;
placing the assembly in an encapsulation device capable of surrounding the sides of the assembly with a seal;
putting the seal in place;
wherein said encapsulation device is capable of deforming the glazed unit during the placement of the seal. cm 13. The method of the claim 12, wherein it further comprising, before the assembly step, a step of chemically or thermally strengthening the first glass sheet and/or the second glass sheet.

14. The glazed unit according to claim 1, wherein the first glass sheet has a thickness of less than 1.2 mm and the second glass sheet has a thickness of less than 1.2 mm.

15. The laminated glazed unit according to claim 2, wherein the first glass sheet has a thickness of less than 1.2 mm and the second glass sheet has a thickness of less than 1.2 mm.

16. The glazed unit according to claim 10, wherein the glazed unit has a thickness not exceeding 3 mm.

17. The glazed unit according to claim 16, wherein the glazed unit has a thickness not exceeding 2 mm.

18. The method according to claim 12, wherein the first glass sheet has a thickness of less than 1.2 mm and the second glass sheet has a thickness of less than 1.2 mm.
